(19) United States
(12) Patent Application Publication
(10) Pub. No.: US 2008/0120548 A1
(43) Pub. Date: May 22, 2008

(54) System And Method For Processing User Interaction Information From Multiple Media Sources

(76) Inventors: Mark Morita, Arlington Heights, IL (US); Prakash Mahesh, Hoffman Estates, IL (US); Murali Kumaran Kariathungal, Hoffman Estates, IL (US); Jeffrey James Whipple, Severn, MD (US); Denny Wingchung Lau, Redwood City, CA (US); Eliot Lawrence Siegel, Severna Park, MD (US); Khan Mohammad Siddiqui, Timonium, MD (US)

Correspondence Address: MCANDREWS HELD & MALLOY, LTD, 500 WEST MADISON STREET, SUITE 3400, CHICAGO, IL, 60661, US

(21) Appl. No.: 11/562,581

(22) Filed: Nov. 22, 2006

(51) Int. Cl. G06F 3/00

(52) U.S. Cl. 715/717

(57) ABSTRACT

A system and method for processing data on user interactions with a workstation. The system comprises an information system that includes a data storage device. An audio microphone capable of capturing workstation user voice data is linked to the information system. An eye-tracking device capable of capturing workstation user eye-movement data is linked to the information system. A display screen capture routine capable of capturing video display data from a workstation display is linked to the information system. A user input capture routine capable of capturing input data entered into the workstation by the workstation user is linked to the information system. The voice data, eye-movement data, video display data and input data for the workstation user are captured simultaneously and the data are recorded on the data storage device with time information that allows synchronization of the data.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to a system and method for processing user interaction data obtained from multiple media sources. In particular, the present invention relates to a system and method for tracking and presenting user interactions with a workstation to improve the understanding of user behaviors.

A clinical or healthcare environment is a crowded, demanding environment that would benefit from organization and improved ease of use of imaging systems, data storage systems and other equipment used in the healthcare environment. A healthcare environment, such as a hospital or clinic, encompasses a large array of professionals, patients and equipment. Personnel in a healthcare facility typically manage a plurality of patients, systems and tasks to provide quality service to patients. Healthcare personnel may encounter many difficulties or obstacles in their workflow.

A variety of distractions in a clinical environment may frequently interrupt medical personnel or interfere with their job performance. Furthermore, workspaces, such as a radiology workspace, may become cluttered with a variety of monitors, data input devices, data storage devices and communication device, for example. Cluttered workspaces may result in inefficient workflow and service to clients, which may impact a patient's health and safety or result in liability for a healthcare facility. Data entry and access is also complicated in a typical healthcare facility.

Healthcare environments, such as hospitals or clinics, include information systems, such as hospital information systems (HIS), radiology information systems (RIS), clinical information systems (CIS) and cardiovascular information systems (CVIS), and storage systems, such as picture archiving and communication systems (PACS), library information systems (LIS) and electronic medical records (EMR). Information stored may include patient medical histories, imaging data, test results, diagnosis information, management information and/or scheduling information, for example. The information may be centrally stored or divided among a plurality of locations. Healthcare practitioners may desire to access patient information or other information at various points in a healthcare workflow.

Thus, management of multiple and disparate devices, positioned within an already crowded environment, that are used to perform daily tasks is difficult for medical or healthcare personnel. In a healthcare environment involving extensive interaction with a plurality of devices, such as keyboards, computer mouse devices, imaging probes and surgical equipment, systems can be complicated to use and also repetitive motion disorders can develop for system users. A system and method capable of reducing some of the complications of system use and/or reducing the repetitive motion associated with repetitive motion injuries would be desirable.

Systems with software tracking applications have been used to track user keyboard and mouse interactions, but such tracking information alone has limited usefulness in enhancing user interaction with an information system. Furthermore, other disparate tracking applications such as video devices have been used to track how an individual interacts with a software application. Tracking with a video device alone also has limited usefulness since the user will generally modify their natural behavior if they know they are being observed. Environmental factors can also diminish the usefulness of video tracking devices where, for example, there are difficulties focusing the camera or there are poor lighting conditions.

Thus, there is a need for a system and method for tracking and processing user interactions with a workstation of a system that allows for improved understanding of user behaviors while operating the system.

### BRIEF DESCRIPTION OF THE INVENTION

Certain embodiments of the present disclosure provide a system for processing data on user interactions with a workstation. The system comprises an information system including a data storage device. The system further comprises an audio microphone linked to the information system. The microphone is capable of capturing workstation user voice data. The system further comprises an eye-tracking device linked to the information system. The eye-tracking device is capable of capturing workstation user eye-movement data. The system further comprises a display screen capture routine linked to the information system. The display screen capture routine is capable of capturing video display data from a workstation display. The system further comprises a user input capture routine linked to the information system. The user input capture routine is capable of capturing input data entered into the workstation by the workstation user. The voice data, eye-movement data, video display data and input data for the workstation user are captured simultaneously and the data are recorded on the data storage device with time information that allows synchronization of the data.

Certain embodiments of the present disclosure provide a method for processing data on user interactions with a workstation. The method comprises simultaneously capturing workstation user data over a predetermined period of time. The workstation user data includes user voice data, user eye-movement data, workstation video display data and user input data. The method further comprises combining the workstation user data into a single media document capable of being presented on a computer display device.

Certain embodiments of the present disclosure provide a computer-readable storage medium having a set of instructions for execution on a computer. The set of instructions comprise a voice capture routine capable of collecting user voice data input to an information system from a link to an audio microphone. The instructions further comprise an eye-movement capture routine capable of collecting user eye-movement data input to the information system from a link to an eye-tracking device. The instructions further comprise a display screen capture routine capable of collecting video display data from a workstation display screen. The instructions further comprise a user input capture routine capable of collecting user input data entered into a workstation by a workstation user. The instructions further comprise an aggregating routine capable of simultaneously triggering the voice capture routine, eye-movement capture routine, display screen capture routine and user input routine and further capable of synchronizing and formatting the user voice data, user eye-movement data, video display data and user input data for presentation on a computer display device.

### BRIEF DESCRIPTION OF THE DRAWINGS

FIG. 1 illustrates several modalities for tracking user interactions according to an embodiment of the present invention.

FIG. 2 illustrates links between user interaction modalities and an information system according to an embodiment of the present invention.

FIG. 3 illustrates a format for presenting user interaction data according to an embodiment of the present invention.

FIG. 4 illustrates a flow diagram for processing user interaction data in an information system according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the accompanying drawings.

### DETAILED DESCRIPTION OF THE INVENTION

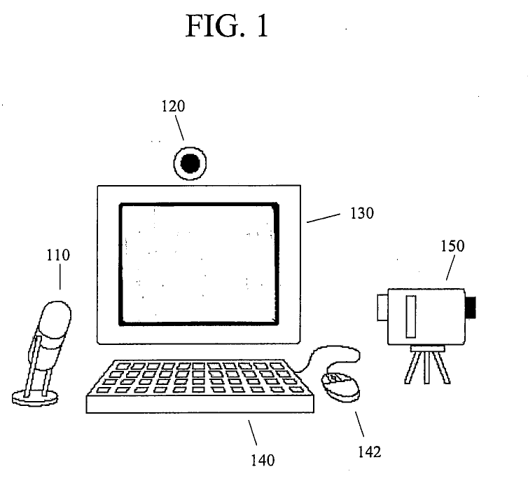

FIG. 1 illustrates an exemplary embodiment of several modalities for obtaining user interaction data from a workstation for use in an information system. The modalities can include an audio microphone 110, an eye-tracking device 120, a workstation display 130 and user input devices 140, 142. In a further exemplary embodiment, the modalities can also include a video camera 150.

The modalities described herein can be used to obtain data on a workstation user's interactions with the workstation. A workstation can include any type of computer or computer terminal device used to control a system such as may be found, for example, in a healthcare or manufacturing environment. Each of the modalities can be linked to an information system that collects data obtained from the various modalities. The information system can be internal or external to the workstation. The information system can process workstation user interaction data obtained from the various modalities. A link between the various modalities and the information system can be in the form of wired, wireless and/or infrared connections which allow communication with the information system of data on user interactions with the workstation.

Audio microphone 110 can be used to capture voice data from a workstation user. The voice data can include information, for example, on the thoughts, frustrations, and/or reasoning of a workstation user. In certain embodiments, the voice data can be converted to text data that can, for example, be combined with the voice data and later used to assess a workstation user's interaction with the workstation.

Eye-tracking device 120 can be used to determine the direction that a workstation user is focusing on the workstation display 130. The information system can then take the data from the eye-tracking device 120 and translate the movements to a pixel location for the workstation display 130, which can be correlated to a certain display screen activity with which the user may be interacting. By tracking where a user is focusing or fixating their visual attention, a user's intent can be inferred and can also be compared with other user interaction data such as, for example, voice data.

The workstation display 130 can be captured using a display screen capture routine. The capture routine can operate on the workstation and send the video display data to the information system. Video display data can also be obtained through a display screen capture routine that operates from the information system and collects video display data through a link between the workstation and the information system. Video display data can allow the information system to identify, for example, where a mouse pointer is moved or what events are happening on the screen during a user's session on the workstation.

Data from workstation user input devices, such as a keyboard 140 or mouse 142, can be collected with a user input capture routine. Workstation user input data can be parsed based on predetermined criteria to establish certain interactions that are desired to be identified as having occurred during a workstation user session.

Video camera 150 can be used to capture data on a workstation user's facial expressions and/or non-facial body language. Video camera 150 can be set at a location relative to the workstation that reduces the workstation users awareness of the presence of video camera 150. For example, video camera 150 can be placed on the ceiling of the room where the workstation is located or it can be indiscreetly built into the workstation.

The workstation user interaction data described herein can be collected simultaneously and synchronized, for example, using date and time data that corresponds with data collected for each user interaction modality. The user interaction data can be individually saved for each modality in separate data files that can be stored on a data storage device, such as for example, a magnetic or optical disk, solid-state computer storage media, or any type of device that preserves digital information for later retrieval.

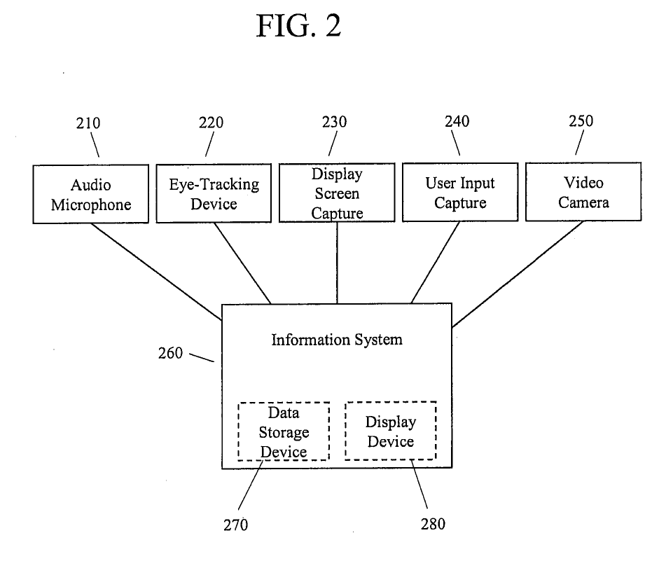

FIG. 2 illustrates links between user interaction modalities and an information system. Multiple applications and/or devices for tracking user interactions with a workstation can be linked to an information system that simultaneously collects data from the linked applications and/or devices. Simultaneous, as used herein, can mean at the same time or within a range of several seconds. The multiple applications and devices for tracking user interactions can include an audio microphone 210 for obtaining voice data, an eye-tracking device 220 for obtaining eye-movement data, a display screen capture application 230 for capturing video display data from a workstation display and a user input capture application 240 for capturing data that is manually input into a workstation by a workstation user. In further exemplary embodiments, the multiple elements for tracking user interactions can also include a video camera 250 for recording data on the workstation users facial expressions and/or non-facial body language. Each of the multiple elements for tracking user interactions are capable of capturing the desired user interaction and transmitting the interaction data to an information system 260. The interaction data can be stored on a data storage device 270 that can be located internal or external to the information system 260. The interaction data collected and stored in information system 260 can further contain time information that can be correlated to the collected interaction data from the multiple elements so that the interaction data can be synchronized.

In certain embodiments, the information system can include a display device 280 for displaying the images and/or data collected from the multiple applications and devices. The display device 280 can, for example, be used to display all the user interaction information in a single screen divided into several windows so that all the collected user interaction information can be viewed and/or analyzed together.

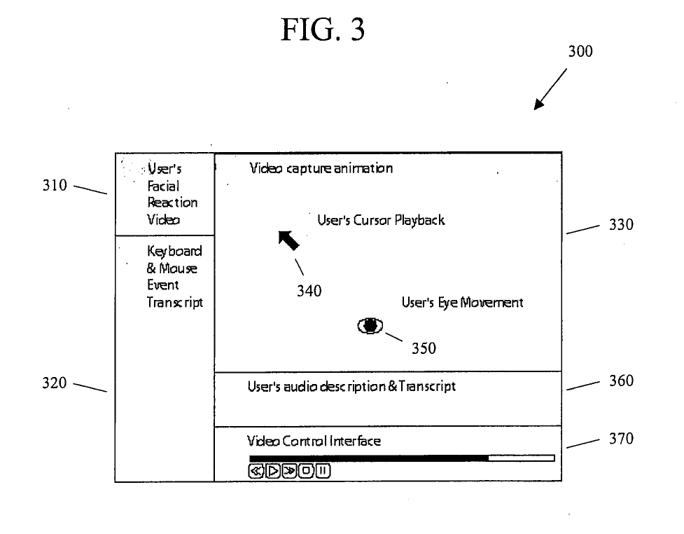

FIG. 3 illustrates an exemplary embodiment of a format for presenting user interaction data. Display screen 300 can be presented, for example, on a display device of an information system such as a computer monitor. Display screen 300 is formatted to present the collected user interaction data in a single screen with several data presentation windows for data collected from each of the modalities described herein. For example, workstation user facial expression data can be presented in video camera window 310. User input data from a workstation keyboard and mouse can be presented in transcript form in user input window 320. Video display data captured from the workstation display can be presented in display screen window 330 which can further show a user's mouse pointer location 340. A projection of the workstation user's eye-movement 350 can also be presented on the display screen window 330. A user's voice data can be presented in an audio window 360 which can include the user's audio description along with a transcript of what the workstation user is saying. The display screen 300 can further include a video control interface 370 to allow an observer of the workstation user interaction data to, for example, start, stop, pause or scroll through the combined display of the user interaction data. The user interaction data can be synchronized for presentation on display screen 300 so that an observer of the workstation user interaction data can see and correlate the data collected from the various modalities. The individual user interaction data windows can also be interacted with alone or designated combinations of data windows can be played back on display screen 300.

The technical effect of the data format presented in display screen 300 is to allow an observer of the workstation user interaction data to better understand how a workstation user is interacting with the workstation and better understand a workstation user's frustration points with the workstation system. The understanding of the observer can be based, for example, on the facial reactions, body language and verbally articulated user feedback that are simultaneously recorded by the system described herein.

In certain embodiments, the information system described herein can operate passively in collecting data on the workstation user's interactions with the workstation. Thus, the user interaction data are collected without the workstation user having knowledge that data is being collected. In further exemplary embodiments, the user interaction data is stored on a data storage device for later viewing.

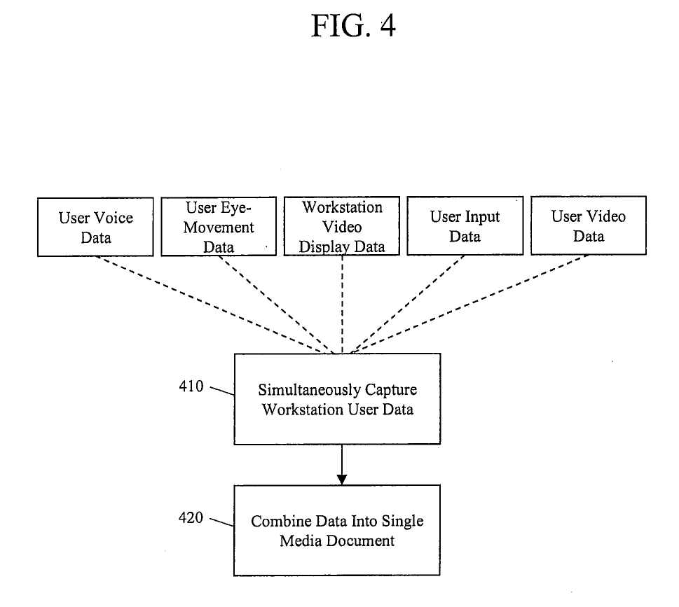

FIG. 4 illustrates a flow diagram for a method of processing user interaction data from a workstation user in an information system. In certain embodiments, the method can include simultaneously capturing workstation user data 410 such as user voice data, user eye-movement data, workstation video display data, user input data, and user video data. The data can then be combined into a single media document 420 for presentation on a computer display device in a format, such as for example, illustrated in FIG. 3. The workstation user data can also be stored for later presentation on a computer display device. In other exemplary embodiments, the method of processing user interaction data can include converting voice data to text data and/or translating eye-movement data to position data that corresponds to a pixel location on the workstation video display.

The workstation user data can be captured over a predetermined period of time and can further be collected for multiple workstation user that can be differentiated by, for example, login accounts. The information system can also, for example, be able to distinguish different workstation users by a workstation user's pattern of operating the workstation.

Certain embodiments include a computer-readable storage medium having a set of instructions for execution on a computer. The set of instructions can include a voice capture routine for collecting user voice data that can be obtained from a link between an information system and an audio microphone. The set of instructions can further include an eye-movement capture routine for collecting user eye-movement data that can be obtained from a link between the information system and an eye-tracking device. The eye-movement capturing routine can also determine a location a user is looking at on a workstation display. The instructions can further include a display screen capture routine for collecting full-screen video display data from the workstation display and a user input capture routine for collecting user input data entered into a workstation by a workstation user. The set of instructions can also include an aggregating routine for simultaneously triggering the voice capture routine, eye-movement capture routine, display screen capture routine and user input routine. The aggregating routine can further synchronize and format the user voice data, user eye-movement data, video display data and user input data for presentation on a computer display device. In other exemplary embodiments, the set of instructions can include a video camera capture routine for collecting user facial expression and/or body language data that can further be aggregated for presentation on a computer display device. In certain embodiments, the set of instructions for the voice capture routine can also includes a subroutine for converting voice data into text. In certain embodiments, the set of instructions for the display screen capture routine can further include a subroutine for obtaining the position of a mouse pointer on the workstation display.

The systems described herein have numerous useful applications. For example, such a systems can be useful for healthcare information systems, manufacturing information systems, or other applications where a user interacts with a computer workstation.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for processing data on user interactions with a workstation, said system comprising:
(a) an information system including a data storage device;
(b) an audio microphone linked to said information system, said microphone capable of capturing workstation user voice data;
(c) an eye-tracking device linked to said information system, said eye-tracking device capable of capturing workstation user eye-movement data;
(d) a display screen capture routine linked to said information system, said display screen capture routine capable of capturing video display data from a workstation display;
(e) a user input capture routine linked to said information system, said user input capture routine capable of capturing input data entered into the workstation by the workstation user,
wherein said voice data, eye-movement data, video display data and input data for the workstation user are captured simultaneously and said data are recorded on said data storage device with time information that allows synchronization of said data.

2. The system of claim 1, further comprising a video camera linked to said information system, said video camera capable of capturing user video data that includes facial expressions of the workstation user, wherein said user video data are recorded on said data storage device with time information that allows said user video data to be synchronized with said voice data, eye-movement data, video display data and input data.

3. The system of claim 2, wherein said user video data further includes non-facial body language of the workstation user.

4. The system of claim 1, wherein said information system further includes a display device capable of displaying at least one of images and data processed from each of said voice data, eye-movement data, video display data and input data.

5. The system of claim 1, wherein said voice data is converted to text data capable of being synchronized with said voice data.

6. The system of claim 5, wherein said text data is further capable of being displayed on a display device of said information system.

7. The system of claim 1, wherein said input data is obtained from at least one of a computer keyboard and a computer mouse connected to the workstation.

8. The system of claim 1, wherein said information system is capable of translating said eye-movement data obtained from said eye-tracking device to a pixel location on said workstation display.

9. The system of claim 1, wherein said video display data includes the position of a mouse pointer.

10. The system of claim 1, wherein said voice data, eye-movement data, video display data and input data are combined into a single media document capable of being displayed on a display device.

11. A method for processing data on user interactions with a workstation, said method comprising:
(a) simultaneously capturing workstation user data over a predetermined period of time, said workstation user data including user voice data, user eye-movement data, workstation video display data and user input data; and
(b) combining said workstation user data into a single media document capable of being presented on a computer display device.

12. The method of claim 11, wherein said workstation user data further includes user video data including facial expressions of the workstation user.

13. The method of claim 12, wherein said user video data further includes non-facial body language of the workstation user.

14. The method of claim 11, further comprising storing said work station user data on a data storage device with time information that allows synchronization of said stored data for subsequent presentation of said stored data on said computer display device.

15. The method of claim 11, further comprising converting said voice data to text data capable of being synchronized with said voice data for presentation on said computer display device.

16. The method of claim 11, further comprising translating said eye-movement data to position data corresponding to a pixel location from a workstation video display.

17. A computer-readable storage medium having a set of instructions for execution on a computer, said set of instructions comprising:
(a) a voice capture routine capable of collecting user voice data input to an information system from a link to an audio microphone;
(b) an eye-movement capture routine capable of collecting user eye-movement data input to said information system from a link to an eye-tracking device;
(c) a display screen capture routine capable of collecting video display data from a workstation display screen; and
(d) a user input capture routine capable of collecting user input data entered into a workstation by a workstation user; and
(e) an aggregating routine capable of simultaneously triggering said voice capture routine, eye-movement capture routine, display screen capture routine and user input routine and further capable of synchronizing and formatting said user voice data, user eye-movement data, video display data and user input data for presentation on a computer display device.

18. The computer-readable medium of claim 17, wherein said set of instructions further comprises a video camera capture routine capable of collecting user video data input to said information system from a link to a video camera, wherein said aggregating routine is further capable of combining and synchronizing said user video data with said voice data, eye-movement data, video display data and input data for presentation on a computer display device.

19. The computer-readable medium of claim 17, wherein said set of instructions for said voice capture routine further includes a subroutine for converting said voice data into text.

20. The computer-readable medium of claim 17, wherein said set of instructions for said display screen capture routine further includes a subroutine for obtaining the position of a mouse pointer on said workstation display.
